(19) United States
(12) Patent Application Publication
(10) Pub. No.: US 2013/0340006 A1
(43) Pub. Date: Dec. 19, 2013

(54) EYE-TRACKING NAVIGATION

(71) Applicant: Avery Audrey Kwan, Oakland, CA (US)

(72) Inventor: Avery Audrey Kwan, Oakland, CA (US)

(73) Assignee: MobiTV, Inc., Emeryville, CA (US)

(21) Appl. No.: 13/523,368

(22) Filed: Jun. 14, 2012

(51) Int. Cl. H04N 5/445

(52) U.S. Cl. 725/39

(57) ABSTRACT

Described herein are techniques for navigating a user interface based on eye-tracking information. According to various embodiments, a user interface may be presented on a display screen at a computing device. The user interface may provide a plurality of actions to perform based on user input. Eye tracking information may be received via an optical sensor at the computing device. The eye tracking information may describe a state of one or both eyes of an individual located proximate to the computing device. One of the plurality of actions may be selected for performance based on the received eye tracking information.

### TECHNICAL FIELD

The present disclosure relates generally to user interface navigation based on eye-tracking information.

### DESCRIPTION OF RELATED ART

Mechanisms for navigating media content currently rely on key/button presses, swipes, and/or entry to search strings. However, the volume of content available makes navigation difficult even with the variety of available navigation mechanisms. Users may also be situated in a position away from a screen or input device that makes it difficult to perform navigation operations. Some user input devices may have limited functionality and may not be able to effectively perform desired navigation operations.

### BRIEF DESCRIPTION OF THE DRAWINGS

The disclosure may best be understood by reference to the following description taken in conjunction with the accompanying drawings, which illustrate particular embodiments.

FIG. 1 illustrates one example of a system that can be used with various techniques and mechanisms of the present invention.

FIG. 2 illustrates a particular example of a network that can use the techniques and mechanisms of the present invention.

FIG. 3 illustrates a particular example of a content delivery system.

FIG. 4 illustrates a particular example of a mosaic video stream.

FIG. 5 illustrates another particular example of a mosaic video stream.

FIG. 6 illustrates a particular example of an overlay corresponding to a mosaic video stream

FIG. 7 illustrates one technique for navigating a user interface at a client device.

FIG. 8 illustrates one technique for selecting an action based on eye-tracking information.

FIG. 9 illustrates one technique for presenting a personalized user interface based on eye-tracking information.

FIG. 10 illustrates a particular example of device receiving a mosaic video stream and providing an overlay.

FIG. 11 illustrates a particular example of server processing for providing a mosaic video stream.

### DESCRIPTION OF EXAMPLE EMBODIMENTS

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

For example, the techniques of the present invention will be described in the context of fragments, particular servers and encoding mechanisms. However, it should be noted that the techniques of the present invention apply to a wide variety of different fragments, segments, servers and encoding mechanisms. In the following description, numerous specific details are set forth in order to provide a thorough understanding of the present invention. Particular example embodiments of the present invention may be implemented without some or all of these specific details. In other instances, well known process operations have not been described in detail in order not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise. For example, a system uses a processor in a variety of contexts. However, it will be appreciated that a system can use multiple processors while remaining within the scope of the present invention unless otherwise noted. Furthermore, the techniques and mechanisms of the present invention will sometimes describe a connection between two entities. It should be noted that a connection between two entities does not necessarily mean a direct, unimpeded connection, as a variety of other entities may reside between the two entities. For example, a processor may be connected to memory, but it will be appreciated that a variety of bridges and controllers may reside between the processor and memory. Consequently, a connection does not necessarily mean a direct, unimpeded connection unless otherwise noted.

### Overview

User eye tracking information may be monitored and tracked in the context of electronic program guides and other user interfaces. The electronic program guides may be grids, mosaics, tiles, images, etc., structured in a time based, channel based, content based, search based, character based, or other entity based manner. When user eye-tracking information reveals a preference for a particular content item or category of content items, related content may be presented to the user in the program guide, in a content stream, or as advertising. When user eye-tracking information indicates that a user may wish to perform an action within the user interface, the action may be performed by the computing device. Accordingly, users may navigate the user interfaces at least in part by eye-movement.

### Example Embodiments

According to various embodiments, eye tracking information may be used to navigate a user interface such as an electronic program guide displayed at a computing device. For example, after detecting that a user has gazed at a particular content item in an electronic program guide, the computing device may cause that content item to be presented for playback. As another example, after detecting that a user has gazed at a designated portion of a display screen, the computer may cause a user interface to be updated to display new information.

According to various embodiments, eye tracking information may be used to determine subconscious and/or less biased information about true user interests and engagement. For example, a user may often gaze at a particular type of content despite not explicitly indicating an interest in the content because the user is unaware of the preference. As another example, the user may be aware of the preference but have already viewed the content in another medium. In this case, the user's attention may be drawn to the content even though the user is unlikely to watch the content again. By monitoring and tracking this information, the monitoring agent may infer that the user is interested in the content or in related content.

In some instances, a user may be aware of a preference but may not explicitly indicate the preference. For instance, the user may enjoy basketball but may tend to listen to sports reporting on the radio rather than view basketball programming on a mobile device. In such a case, the user may often gaze at basketball content in a content selection guide but may rarely or never select the content. However, the user may be receptive to viewing basketball content if more offerings are shown, such as games played by the user's favorite teams. By tracking the user's eye movements, these and other such preferences may be revealed.

According to various embodiments, content and advertising suited to a particular user's interests could be provided in response to eye tracking information. Based on the user's eye activity, information regarding the user's preferences may be estimated or inferred. Then, content presented to the user, such as content included in a digital content selection guide, may be updated to include more of the type of content that attracts the user's attention.

According to various embodiments, various types of eye tracking information may be monitored. The eye-tracking information that may be monitored and processed may include, but is not limited to: user eye movement velocity and acceleration, the location at which a user is gazing, the duration or “dwell” of a user's gaze at a particular location or locations, the dilation of a user's pupils, and/or a blink frequency or other eye-related information. Also, the eye-tracking information may include data used to identify a user's facial expressions or other indications of a user's mood, opinion, or impressions when viewing content. In addition, the eye-tracking information may include information related to the movement, orientation, or positioning of a user's head. This information may be used to detect nodding, head tilting, or other behaviors. Accordingly, although the information may be referred to herein as “eye-tracking information”, in some instances this information may include data regarding the user's facial movements, head location, head orientation, or other such related information.

According to various embodiments, content and advertising suited to a particular user's interests could be provided in response to eye tracking information. For instance, a user may often gaze at a particular piece of content without ever providing user input explicitly indicating an interest in the content. By monitoring and tracking this information, the monitoring agent may infer that the user is interested in the content or in related content. For example, the user may be interested in similar content but have already viewed the content in another medium. In this case, the user's attention may be drawn to the content even though the user is unlikely to watch the content again.

According to various embodiments, eye tracking information may be used to evaluate marketing and advertising materials presented on a display device. For example, if an advertisement is shown on a display device, eye tracking information may be used to identify which locations on the advertisement draw the user's attention.

According to various embodiments, eye tracking information may be used to determine points of interest in an image. For example, a content provider may present an image that includes various characters in a movie or television program. Eye tracking information may then be used to determine which of the characters tend to draw the user's attention.

According to various embodiments, content providers and advertisers could be provided with additional information on interest levels and engagement. For example, an advertiser or content provider may be informed of the frequency and duration with which a user or users looked at the advertisement or media content. As another example, an advertiser or content provider may be informed of the velocity and/or acceleration at which a user or users turned attention to a new advertisement or content item displayed on the display screen. As yet another example, an advertiser may be charged for an advertisement on the basis of the actual or estimated time in which the advertisement was viewed by users.

Electronic program guides provide users with information to allow video content selection. Some electronic program guides provide hundreds or thousands of options including numerous channels and video on demand clips. In some instances, electronic program guides can organize content by category, such as dramas, sports, or movies and provide the content in numerically ordered channel listings. In some other instances, popular programs or award winning content is flagged for a user. Electronic program guides may also be filtered. In some examples, non-family oriented programming is filtered based on user selection.

However, providing thousands of channels and video clips to a user results in a large of amount of information and choices. This information may be shown in a part of a display or condensed onto a device screen. The information may scroll automatically or may scroll after user input. In many instances, channels and video clips may be listed in numerical order or alphabetical order. In either case, it takes a tremendous amount of time to sift through content, and even after viewing the titles, a user still may have insufficient information to make an intelligent selection.

Traditionally, navigating an electronic program guide or other user interface involves physically touching a user input device such as a mouse, keyboard, touch screen, or television remote control. However, operating a user input device may distract a user from the material presented on the display screen. Further, the correspondence between a particular type of user input such as a mouse click or keyboard key and an action performed on the electronic program guide may not be apparent to the user. Additionally, many electronic program guides have limited visible control indicators displayed on the display screen in order to increase the portion of the screen available for displaying the electronic program guide itself. Therefore, navigating electronic program guides and other content-related user interfaces using traditional user input techniques may be difficult, inconvenient, distracting, or cumbersome.

According to various embodiments, navigating user interfaces such as electronic program guides may be aided by tracking the eye or eyes of a user of the computing device on which an electronic program guide is displayed. User eye movement velocity, acceleration, and dwell are monitored and tracked to perform navigation operations associated with the viewing of media content including navigation of electronic program guides. A variety of different electronic program guides and media content presentation mechanisms can be manipulated based on eye movement, acceleration, and dwell. Movement and dwell in a particular portion of a display can indicate desired navigation to a different piece of content or a different category or page. If a pattern of motion and/or dwell indicates a desire to perform a particular action, then the action may be performed without requiring explicit user input.

According to various embodiments, various navigation actions for user interfaces based on eye-tracking information may be supported. The types of navigation actions that may be performed for a user interface may include, but are not limited to: panning a viewpoint from which the user interface is displayed, scrolling to a different portion of the user interface, selecting a content item within the user interface, navigating to a different page of the user interface, confirming an action previously selected within the user interface, zooming in or out to a different level of detail within the user interface, activating a button or other affordance displayed within the user interface, or performing any other operation. In particular embodiments, any action that may be performed via traditional user interface devices such as mice, keyboards, touch screens, or remote controllers may be performed at least in part based on eye-tracking.

According to various embodiments, eye tracking information may be used to provide personalized electronic program guides. By monitoring and analyzing a user's eye tracking information, inferences may be drawn regarding the user's preferences. Even though these inferences may not always be entirely accurate, the inferences may allow an improved, personalized content guide to be presented to the user. For instance, if a user is observed to often focus on a particular type of content, then the user may be presented with a personalized content guide that emphasizes that type of content.

According to various embodiments, the techniques and mechanisms described herein may be used in conjunction with grid-based electronic program guides. In many grid-based electronic program guides, content is organized into “channels” that appear on one dimension of the grid and time that appears on the other dimension of the grid. In this way, the user can identify the content presented on each channel during a range of time.

According to various embodiments, the techniques and mechanisms described herein may be used in conjunction with mosaic programming guides. In mosaic programming guides, a display includes panels of actual live feeds as a channel itself. A user can rapidly view many options at the same time. Using the live channel as a background, a lightweight menu-driven navigation system can be used to position an overlay indicator to select video content. Alternatively, numeric or text based navigation schemes could also be used. Providing a mosaic of channels in a single channel instead of merging multiple live feeds into a single display decreases complexity of a device application. Merging multiple live feeds require individual, per channel feeds of content to be delivered and processed at an end user device. Bandwidth and resource usage for delivery and processing of multiple feeds can be substantial. Less bandwidth is used for a single mosaic channel, as a mosaic channel would simply require a video feed from a single channel. The single channel could be generated by content providers, service providers, etc.

According to particular embodiments, mosaic channels include video content such as live video content, looped clip content, trailers, advertisements, etc. Mosaic channels may also include user selected live channels of both live and clip content. The live content and clip streams can be arranged into a variety of visual patterns such as grid, trees, clusters, and circular patterns on a mosaic. A wide variety of other patterns including patterns with overlapping video streams are also possible. In particular examples, mosaic channels are dynamically changing based on popularity and viewership information.

Mosaics can be displayed on a user device in an efficient and effective manner. Bandwidth and processing resources are not wasted as only a single channel needs to be delivered and processed. According to particular embodiments, a relatively lightweight client side application provides an interface for a user to navigate mosaics. In some examples, a mosaic video stream may allow navigation to another mosaic video stream. A mosaic may have an overlay that allows navigation to numerous other mosaics. In particular examples, numeric or text selection mechanisms can be provided to select channel content. For example, particular numeric or text codes can be mapped to particular streams displayed in a mosaic. In other examples, an overlay allows movement and selection of video stream display windows. Advertising can also be supported using overlays on channels. Particular windows can again be mapped to particular streams.

The mapping information may be delivered as part of a stream or may be delivered separately. According to particular embodiments, every mosaic channel has corresponding navigation engine instructions. In particular examples, the navigation engine instructions may correspond to both the channel identifier and the mosaic pattern indicating the placement of videos for the channel.

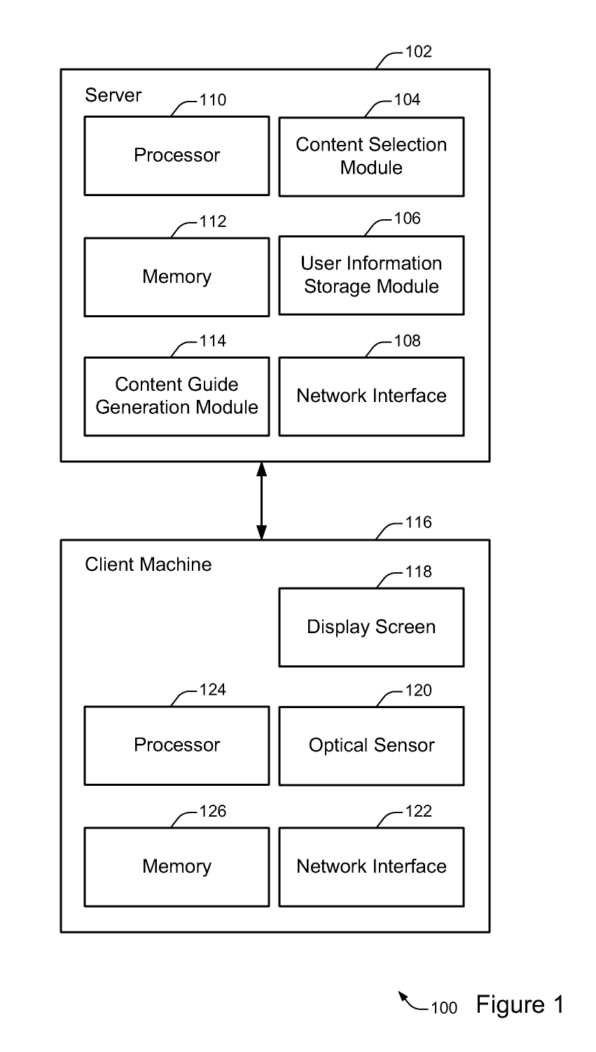

FIG. 1 shows an example of a system 100. According to various embodiments, the system 100 may be used in conjunction with techniques described herein to collect eye tracking information and present personalized content to a user. The system 100 includes a server 102 and a client machine 116. The server and the client machine may communicate via a network interface 108 at the server and a network interface 122 at the client machine.

The client machine includes a processor 124 and memory 126. Additionally, the client machine includes a display screen 118 configured to display content. The client machine also includes an optical sensor 120 operable to collect eye tracking information from an individual in proximity to the client machine.

The server includes a user information storage module 106 operable to store user information such as the eye tracking information collected via the optical sensor 120. The server also includes a content selection module 104 operable to select content for presentation at the client machine based on the collected eye tracking information. In addition, the server includes a content guide generation module 114 operable to generate a content guide for presentation on the client device. As well, the server includes a processor 110 and memory 112.

According to various embodiments, as described herein, a server may include components not shown in FIG. 1. For example, a server may include one or more processors, memory modules, storage devices, and/or communication interfaces. As another example, a server may include software and/or hardware operable to retrieve content and provide the content to client machines.

The user information storage module 106 in the server is operable to store information collected regarding users of devices in communication with the server. For example, the storage module may store eye tracking information collected at client machines. For instance, the eye tracking information may include raw data, such as gaze information or duration. Alternately, or additionally, the eye tracking information may include processed data, such as content items that were focused on by a user. As another example, the storage module may include content selections made by a user. As yet another example, the storage module may include content ratings received from a user.

The content selection module 104 in the server is operable to select content to present at the client device based on the information stored in the storage module 106. According to various embodiments, the selected content may include advertising, media for playback, media for selection in a content guide, or any other content that may be presented on the client device. The content selection module 104 may select content for presentation at the client device at various times, such as when the client device is activated, when a request for content is received at the server, when eye tracking information is received at the server, or at any other time.

According to various embodiments, not all content transmitted to the client machine need be selected based on eye tracking information or any other information about the user. For example, the user may request to see a menu of content. Some of the content may be selected based on user information such as eye tracking information. Alternately, or additionally, some of the content may be selected based on other criteria, such as availability criteria, advertising criteria, revenue criteria, or content categorization criteria.

The content guide generation module 114 is operable to generate a content guide for presentation on a client machine. According to various embodiments, the content guide generation module 114 may create a content guide based on various criteria and including content drawn from various sources. For example, the content guide may include advertising, content provided over a network by a content provider, and/or content already available at the client machine. As another example, the content guide may include content selected based on content availability, user preferences, advertiser preferences, user eye-tracking information, and/or any other information. As discussed herein, the content guide created by the generation module 114 may be a mosaic content guide, a grid-based content guide, or any other digital content guide capable of being used to present content items for selection on a client machine.

According to various embodiments, the content guide generated by the content guide generation module 114 may be configured for user control based on eye-tracking information. For example, the content guide may include one or more designated screen portions that may be used to activate navigation features based on eye activities. In particular embodiments, some or all of these screen portions may be visually identified within the content guide. For instance, a screen portion may appear to be a button or other user interface affordance. In some embodiments, some or all of the screen portions may not be visually identified within the content guide. For instance, the user may be able to navigate to the next page of a content guide by glancing toward the edge of the screen for a designated period of time or at a designated eye movement velocity, even if the screen does not display a navigation button or other user interface affordance at the edge of the screen.

The network interface 108 is configured to receive and transmit communications via a network such as the Internet. According to various embodiments, the network may be a wired network or a wireless network. The network interface may communicate via HTTP, TCP/IP, UDP, or any other communication protocol. Content may be transmitted to the client machine via unicast, multicast, broadcast, or any other technique. Also, content need not be transmitted by the server 102. For example, in particular embodiments the server 102 may select content for presentation, while another server may transmit the content to the client machine.

The client machine 116 may be any device operable to receive content via a network and present the content on the display screen 118. For example, the client machine 118 may be a desktop or laptop computer configured to communicate via the Internet. As another example, the client machine may be a mobile device such as a cellular phone or tablet computer configured to communicate via a wireless network.

The display screen 118 may be any type of display screen operable to present content for display. For example, the display screen may be an LCD or LED display screen. As another example, the display screen may be a touch screen. The client machine 116 may include other components not shown in FIG. 1, such as one or more speakers, additional display screens, user input devices, processors, or memory modules.

The optical sensor 120 is operable to locate and track the state of one or both eyes of an individual in proximity to the client machine. The optical sensor is configured to receive and process light received at the sensor. According to various embodiments, the light received and processed by the optical sensor may be any light on the spectrum capable, including visible light, infrared light, ultraviolet light, or any other kind of light. The specific type of light sensor used may be strategically determined based on factors such as the type of device at which the sensor is located and the likely proximity of the user to the device. In particular embodiments, the light sensor may be a digital camera. Alternately, or additionally, an infrared sensor may be used.

According to various embodiments, more than one light sensor may be used. For example, information from two light sensors may be combined to triangulate a location of an eye. As another example, different types of light sensors may be used to provide better eye tracking information in various lighting conditions.

The network interface 122 is configured to receive and transmit communications via a network such as the Internet. According to various embodiments, the network may be a wired network or a wireless network. The network interface may communicate via HTTP, TCP/IP, UDP, or any other communication protocol. Content may be received at the client machine via unicast, multicast, broadcast, or any other transmission technique.

According to various embodiments, the components shown in the client or server in FIG. 1 need not be physically located within the same machine. For example, the optical sensor 120 shown in FIG. 1 may be a web camera in communication with the client machine via an interface such as USB. As another example, the user information storage module 106 may be located outside the server 102. For instance, the user information may be stored in a network storage location in communication with the server 102 via the network interface 108.

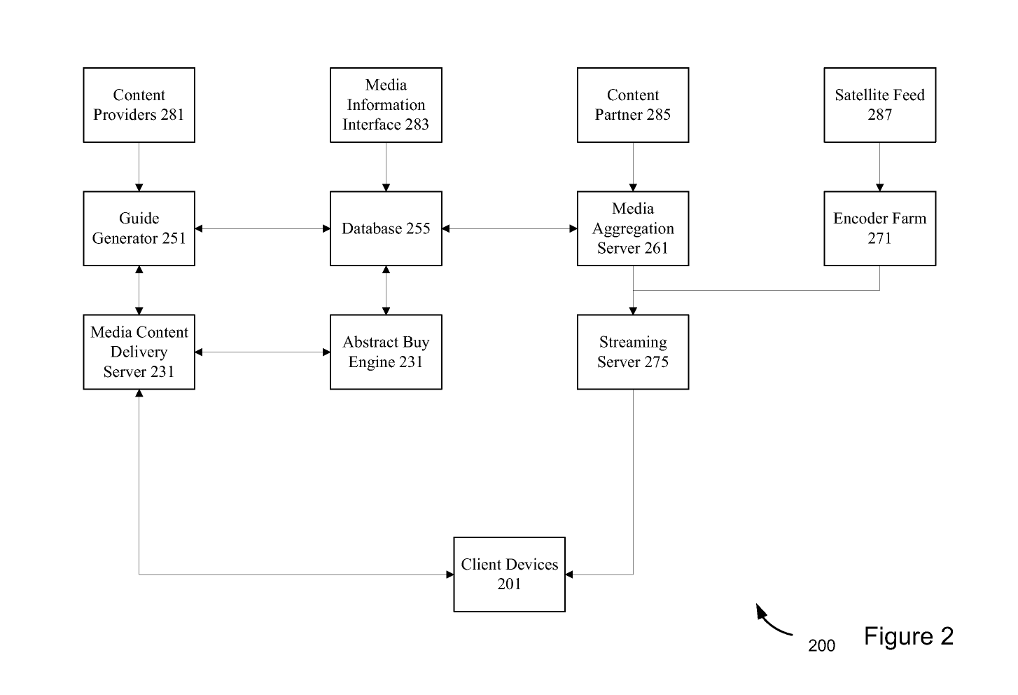

FIG. 2 is a diagrammatic representation showing one example of a network that can use the techniques of the present invention. According to various embodiments, media content is provided from a number of different sources 285. Media content may be provided from film libraries, cable companies, movie and television studios, commercial and business users, etc. and maintained at a media aggregation server 261. Any mechanism for obtaining media content from a large number of sources in order to provide the media content to mobile devices in live broadcast streams is referred to herein as a media content aggregation server. The media content aggregation server 261 may be clusters of servers located in different data centers. According to various embodiments, content provided to a media aggregation server 261 is provided in a variety of different encoding formats with numerous video and audio codecs. Media content may also be provided via satellite feed 257.

An encoder farm 271 is associated with the satellite feed 287 and can also be associated with media aggregation server 261. The encoder farm 271 can be used to process media content from satellite feed 287 as well as possibly from media aggregation server 261 into potentially numerous encoding formats. According to various embodiments, file formats include open standards MPEG-1 (ISO/IEC 11172), MPEG-2 (ISO/IEC 13818-2), MPEG-4 (ISO/IEC 14496), as well as proprietary formats QuickTime™, ActiveMovie™, and RealVideo™. Some example video codecs used to encode the files include MPEG-4, H.263, and H.264. Some example audio codecs include Qualcomm Purevoice™ (QCELP), The Adaptive Multi-Narrow Band (AMR-NB), Advanced Audio coding (AAC), and AACPlus. The media content may also be encoded to support a variety of data rates. The media content from media aggregation server 261 and encoder farm 271 is provided as live media to a streaming server 275. In one example, the streaming server is a Real Time Streaming Protocol (RTSP) server 275. Media streams are broadcast live from an RTSP server 275 to individual client devices 201. A variety of protocols can be used to send data to client devices.

Possible client devices 201 include personal digital assistants (PDAs), cellular phones, personal computing devices, personal computers etc. According to various embodiments, the client devices are connected to a cellular network run by a cellular service provider. IN other examples, the client devices are connected to an Internet Protocol (IP) network. Alternatively, the client device can be connected to a wireless local area network (WLAN) or some other wireless network. Live media streams provided over RTSP are carried and/or encapsulated on one of a variety of wireless networks.

The client devices are also connected over a wireless network to a media content delivery server 231. The media content delivery server 231 is configured to allow a client device 201 to perform functions associated with accessing live media streams. For example, the media content delivery server allows a user to create an account, perform session identifier assignment, subscribe to various channels, log on, access program guide information, obtain information about media content, etc. According to various embodiments, the media content delivery server does not deliver the actual media stream, but merely provides mechanisms for performing operations associated with accessing media. In other implementations, it is possible that the media content delivery server also provides media clips, files, and streams. The media content delivery server is associated with a guide generator 251. The guide generator 251 obtains information from disparate sources including content providers 281 and media information sources 283. The guide generator 251 provides program guides to database 255 as well as to media content delivery server 231 to provide to client devices 201.

According to various embodiments, the guide generator 251 obtains viewership information from individual client devices. In particular embodiments, the guide generation 251 compiles viewership information in real-time in order to generate a most-watched program guide listing most popular programs first and least popular programs last. The client device 201 can request program guide information and the most-watched program guide can be provided to the client device 201 to allow efficient selection of video content. According to various embodiments, guide generator 251 is connected to a media content delivery server 231 that is also associated with an abstract buy engine 241. The abstract buy engine 241 maintains subscription information associated with various client devices 201. For example, the abstract buy engine 241 tracks purchases of premium packages.

The media content delivery server 231 and the client devices 201 communicate using requests and responses. For example, the client device 201 can send a request to media content delivery server 231 for a subscription to premium content. According to various embodiments, the abstract buy engine 241 tracks the subscription request and the media content delivery server 231 provides a key to the client 201 to allow it to decode live streamed media content. Similarly, the client device 201 can send a request to a media content delivery server 231 for a most-watched program guide for its particular program package. The media content delivery server 231 obtains the guide data from the guide generator 251 and associated database 255 and provides appropriate guide information to the client device 201.

Although the various devices such as the guide generator 251, database 255, media aggregation server 261, etc. are shown as separate entities, it should be appreciated that various devices may be incorporated onto a single server. Alternatively, each device may be embodied in multiple servers or clusters of servers. According to various embodiments, the guide generator 251, database 255, media aggregation server 261, encoder farm 271, media content delivery server 231, abstract buy engine 241, and streaming server 275 are included in an entity referred to herein as a media content delivery system.

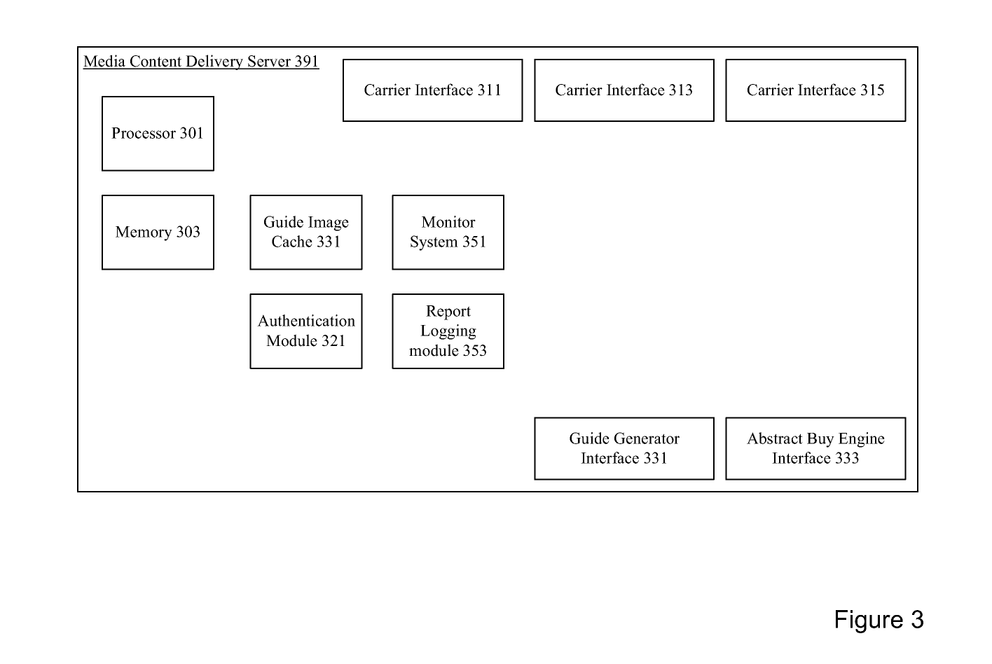

FIG. 3 is a diagrammatic representation showing one example of a media content delivery server 391. According to various embodiments, the media content delivery server 391 includes a processor 301, memory 303, and a number of interfaces. In some examples, the interfaces include a guide generator interface 341 allowing the media content delivery server 391 to obtain program guide information. The media content delivery server 391 also can include a program guide cache 331 configured to store program guide information and data associated with various channels. The media content delivery server 391 can also maintain static information such as icons and menu pages. The interfaces also include a carrier interface 311 allowing operation with mobile devices such as cellular phones operating in a particular cellular network. The carrier interface allows a carrier vending system to update subscriptions. Carrier interfaces 313 and 315 allow operation with mobile devices operating in other wireless networks. An abstract buy engine interface 343 provides communication with an abstract buy engine that maintains subscription information.

An authentication module 321 verifies the identity of mobile devices. A logging and report generation module 353 tracks mobile device requests and associated responses. A monitor system 351 allows an administrator to view usage patterns and system availability. According to various embodiments, the media content delivery server 391 handles requests and responses for media content related transactions while a separate streaming server provides the actual media streams. In some instances, a media content delivery server 391 may also have access to a streaming server or operate as a proxy for a streaming server. But in other instances, a media content delivery server 391 does not need to have any interface to a streaming server. In typical instances, however, the media content delivery server 391 also provides some media streams. The media content delivery server 391 can also be configured to provide media clips and files to a user in a manner that supplements a streaming server.

Although a particular media content delivery server 391 is described, it should be recognized that a variety of alternative configurations are possible. For example, some modules such as a report and logging module 353 and a monitor 351 may not be needed on every server. Alternatively, the modules may be implemented on another device connected to the server. In another example, the server 391 may not include an interface to an abstract buy engine and may in fact include the abstract buy engine itself. A variety of configurations are possible.

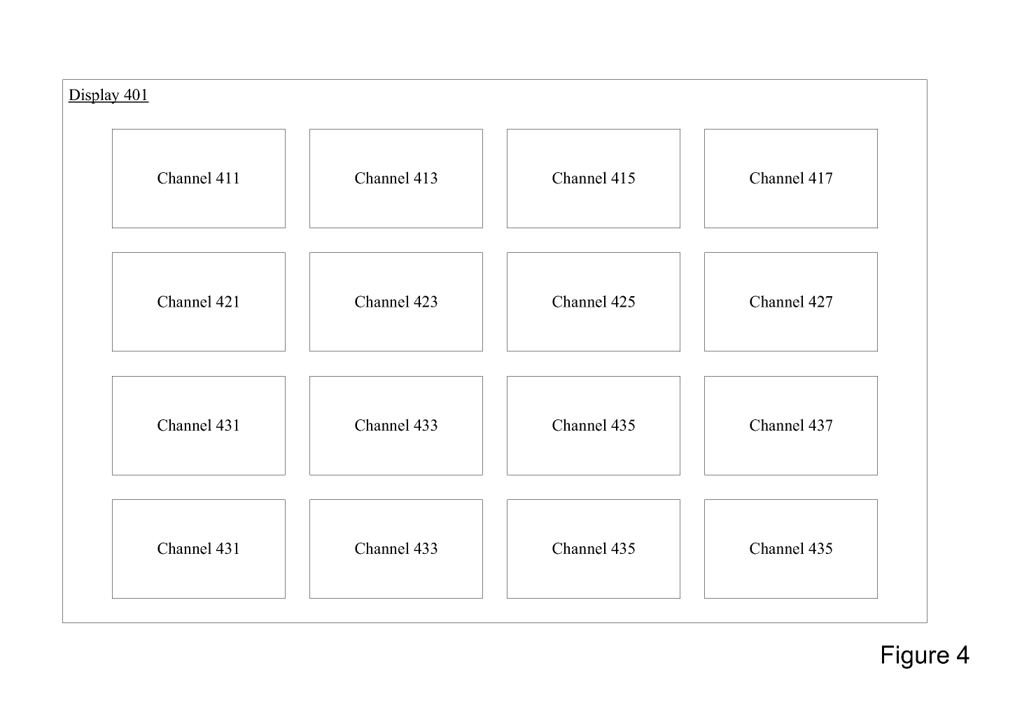

FIG. 4 illustrates a particular example of a mosaic video stream. According to particular embodiments, a display 401 is configured to show a mosaic video stream providing multiple video streams including channels 411-435. With a mosaic video stream, a user can view video streams for channels 411-435 using a single channel feed on a single channel. Each channel may show live or video clip content. According to particular embodiments, a mosaic video stream shown on a display 401 is not generated by an end device receiving multiple video streams and aggregating the streams onto a single display. Although this may be possible, this would consume a large amount of bandwidth and processing resources. Some devices do not have the ability to render multiple video feeds. According to particular embodiments, the mosaic video stream is generated by a server associated with a content or service provider. The content or service provider provides multiple video streams to an end user by aggregating them onto a single channel.

In particular examples, the content or service provider has the ability to generate mosaic video streams providing live or looped content for multiple channels in a visual pattern for viewing on a display 401. Navigation mapping information can also be provided to allow selection of a channel by a user. According to particular embodiments, the mosaic video stream is provided with a listing of channels and coordinate information corresponding to the position of the channel window in the mosaic video stream. For example, channel 411 may be provided with a pair of coordinates, four coordinates, a coordinate and a size, etc. A variety of position information can be sent to a device to allow a device to provide an appropriate overlay for video content selection.

The video content for a mosaic video stream can be selected using a variety of criteria. According to particular embodiments, the real-time most popular video content is selected for inclusion in a mosaic video stream. Real-time viewership information can be used to order channels based on popularity. In particular examples, video content may include channels for a particular category or type of video content. In still other particular embodiments, video content may be selected based on ratings or user selection. For example, a user may select particular channels for a personalized mosaic video stream that a content provider or service provider generates for the user.

According to particular embodiments, a provider generates numerous mosaic video streams based on various criteria. The mosaic video streams may each have their own navigation mapping to allow a user to select video content using a device provided overlay. The mosaic video stream may also show multiple live and clip feeds in a variety of visual arrangements.

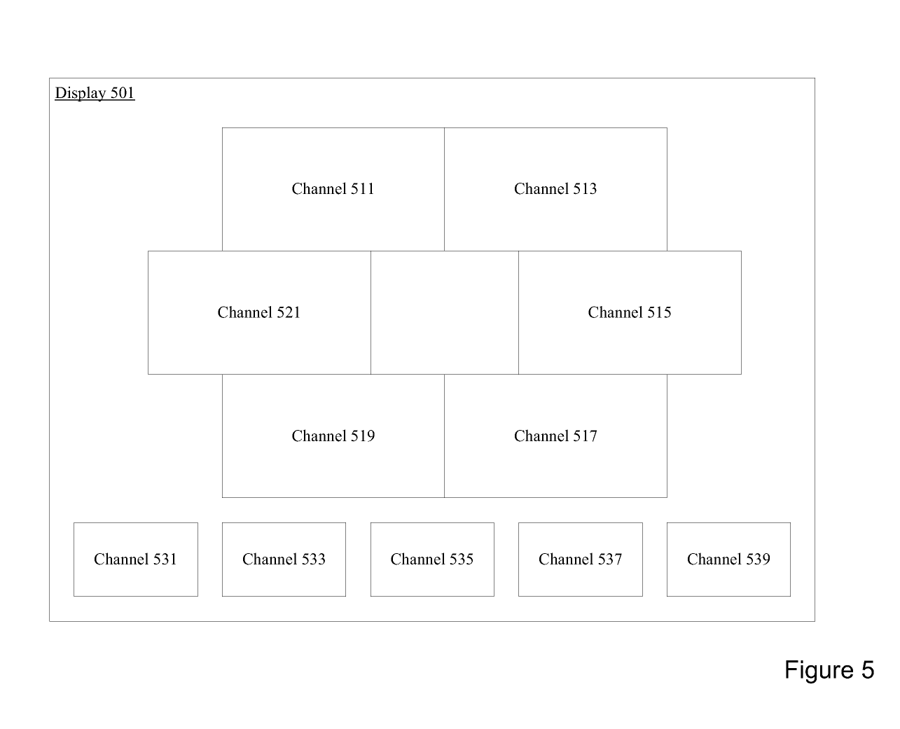

FIG. 5 illustrates another example of a mosaic video stream. The display 501 shows channels 511, 513, 515, 517, 519, and 521 in a circular arrangement with other channels 531, 533, 535, 537, and 539 listed as auxiliary channels at the bottom of a display 501. A variety of arrangements are possible. The mosaic video stream provides navigation mapping information to a device. According to various embodiments, the channel listing for the mosaic video stream is provided with position information indicating where the video streams for each channel are located in the mosaic video stream display.

According to particular embodiments, the video streams provided in each channel window change with time. A provider may alternate between movie channels and sports channels aggregated in a mosaic video stream. Alternatively, real time most popular content may be shifted into a more prominent position. According to particular embodiments, a device provides an overlay for a mosaic video stream to allow a user to select content. Navigating to another mosaic view or to a particular part of a mosaic view in order to zoom or change view entails a channel change. In particular examples, the overlays allow interaction where mosaic patterns associated with a mosaic video stream do not.

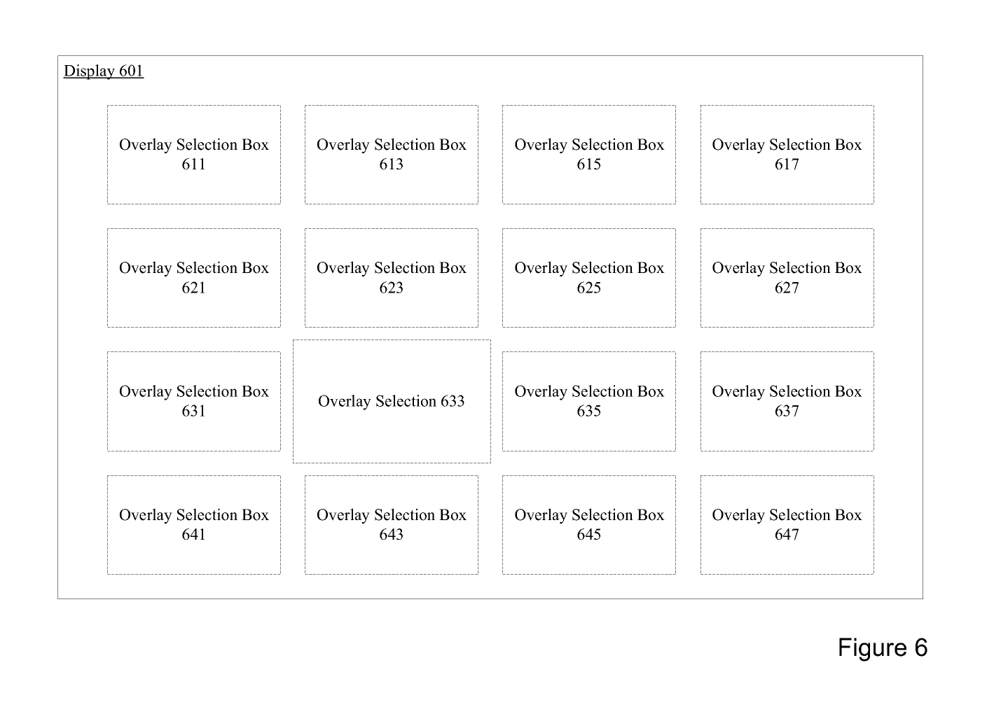

FIG. 6 illustrates a particular example of an overlay. According to particular embodiments, a client side application provides overlays corresponding to particular mosaic video streams. Overlays may be partially or completely transparent, allowing a user to interact with a mosaic view. Overlays may be generated or predefined. In particular examples, a device receives mapping information from a provider and shows a display 601 with overlay selection boxes 611-655. According to particular embodiments, a user navigates the overlay selection boxes and selects video content by identifying a particular overlay selection such as overlay selection 655. The overlay selection boxes may be arranged in a variety of visual patterns corresponding to mosaic video streams. In particular examples, an overlay selection 655 highlights a particular video channel when selected. Selecting the channel in overlay selection 633 results in a channel change to allow viewing of the corresponding video content. According to particular embodiments, the overlay has the ability to support customized advertising on channels.

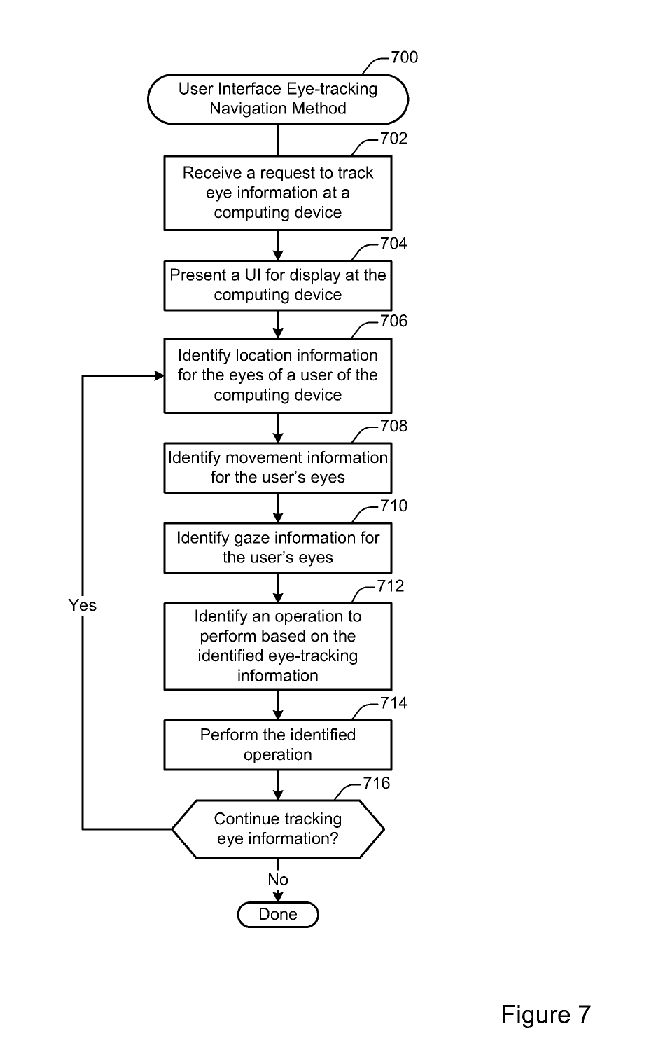

FIG. 7 illustrates a method 700 for navigating a user interface at a client device. According to various embodiments, the method 700 may be performed at any computing device in communication with a server via a network. For instance, the method 700 may be performed at a desktop or laptop computer or at a mobile device such as a tablet or mobile phone.

At 702, a request to track eye information is received at the computing device. According to various embodiments, the request may be received from a remote server in communication with the computing device via a network or may be generated at the device itself. If generated at the device, the request may be automatically generated by a computer program, such as the computer program in which the content is presented. Alternately, the request may be generated in response to user input, such as a user-generated request to initiate tracking of eye information.

At 704, content is presented for display at the computing device. According to various embodiments, the content may be a content guide. Alternately, or additionally, the content may be a user interface for displaying a media content item such as a video. In particular embodiments, one portion of the display screen may be dedicated to displaying a media content item while another portion of the display screen may be dedicated to displaying a content guide.

According to various embodiments, the content may be personalized based on previously-collected eye-tracking information. Alternately, or additionally, some or all of the content initially presented may not be personalized based on eye-tracking information.

According to various embodiments, content may be personalized based on aggregate eye-tracking information. For example, if eye-tracking information indicates that many users are interested in a designated piece of content, then the user may be presented with this content. Such a technique may be useful, for instance, when little is known about the user's preferences with respect to the designated piece of content.

At 706, location information for the eyes of a user of the computing device is identified. The location information may be identified via an optical sensor, as discussed with respect to FIG. 1. The location information may be used to isolate the eye information from other optical information received at the sensor or sensors at the computing device. According to various embodiments, the location information may be identified based on standard image or sensor data processing techniques. For example, facial recognition software may be used to identify the eye location information.

According to various embodiments, one or more users may be selected for eye tracking if more than one user is present near the computing device. For example, the closest or most central user may be selected. The selected user or users need not be physically touching the computing device or operating a user input device in communication with the computing device. Eye tracking information may be collected for any or all of the users in proximity to the computing device.

At 708, movement information is identified for the user's eyes. According to various embodiments, the movement information may include information identifying a direction, velocity, and/or acceleration of the user's eyes. The movement information may be correlated with timing or events associated with the presentation of content on the display screen. For example, the movement information may indicate that soon after a new content selection item was displayed on the screen, the user's eyes quickly moved to focus on the new item. As another example, the movement information may indicate that a user's eyes did not move to focus on a portion of the display screen containing a new content selection item. As yet another example, the movement information may indicate that a user's eyes moved to focus on a portion of the display screen, but that the movement was not very fast.

At 710, gaze information for the user's eyes is identified. According to various embodiments, the gaze information may include information identifying a location and a duration of a user's focus on one or more portions of the display screen. For example, the gaze information may indicate that the user focused on a particular portion of the screen for several seconds, possibly indicating interest in the navigational action or content item displayed there. As another example, the gaze information may indicate that the user focused on many areas of the screen in quick succession, possibly indicating a visual search strategy or a lack of interest in the material displayed on the screen. As yet another example, the gaze information may indicate that the user focused on a navigation-relevant portion of the screen, such as a screen edge or a control panel, possibly indicating a desire to navigate a user interface.

According to various embodiments, the gaze information may include information identifying a dilation of the user's pupil or pupils. In some instances, a user's pupils may dilate if the user views content that the user prefers. Accordingly, if a user's pupils dilate when the user's eyes turn to gaze at a particular content item, then a user may be estimated to prefer or be interested in the content gazed upon. In contrast, if the user's pupils contract when the user's eyes turn to gaze at a particular content item, then the user may be estimated to dislike or not be interested in the content gazed upon.

According to various embodiments, the dilation of the user's pupils may be measured or analyzed relative to the ambient light level. That is, a higher level of ambient light level will generally cause pupillary contraction. Accordingly, this effect may be taken into account when determining the significance of an observed level of pupillary dilation. For example, an observation that a user's pupils are significantly contracted may be somewhat discounted if the ambient light levels are very high. In particular embodiments, pupillary dilation may be observed as a degree of change from a previous state.

At 712, an operation to perform is identified based on the identified eye-tracking information. According to various embodiments, identifying an operation to perform may include identifying a portion of the display screen corresponding to the movement and gaze information is identified. The screen portion may be identified by determining a portion of the display screen focused on by the user's eyes at a designated time instance or during a designated time interval. Then, digital records at the computing device may be analyzed to identify the contents of the portion of the screen during the designated time instance or time interval.

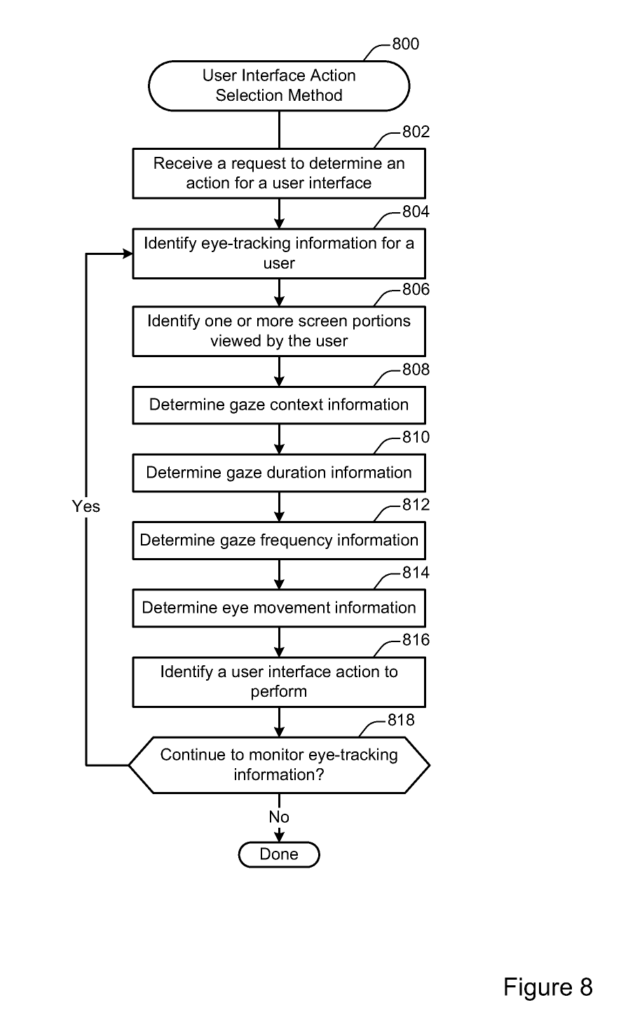

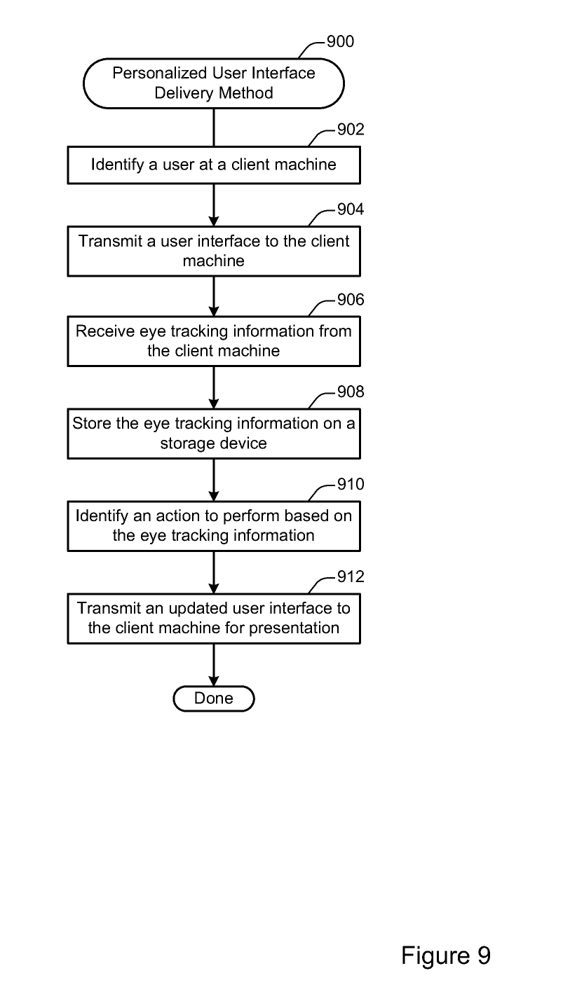

According to various embodiments, different types of operations may be supported within a user interface based on eye-tracking information. These operations may include, but are not limited to: navigating to a next page in a user interface, navigating to a previous page in a user interface, loading content, closing content, pausing content playback, rewinding content playback, fast forwarding content playback, stopping content playback, selecting content for playback, viewing more information regarding a topic, viewing less information regarding a topic, selecting a content channel for viewing, viewing content similar to the content focused on, and/or any other action related to a user interface. The identification of an operation based on eye-tracking information is discussed in further detail in reference to FIGS. 8 and 9.

According to various embodiments, identifying an operation to perform may include transmitting eye-tracking information to a remote server. According to various embodiments, any or all of the information captured by the sensor may be transmitted to the remote server. The specific format for transmitting the information and the specific information that is transmitted may be strategically determined based on criteria such as the data bandwidth of the communication session with the remote server, the capabilities of the computing device, and the techniques for selecting personalized content based on the eye-tracking information.

At 714, the operation identified at operation 712 is performed. According to various embodiments, the identified operation may involve updating the user interface, displaying additional content, displaying less content, or any other operation. Depending on the particular operation performed and the device at which the operation is performed, the operation may be performed by the device alone or by the device in communication with a remote server. For example, the user may navigate to the next page of a programming guide. As another example, the user may request to play a particular video. If the information required to perform these operations is not located on the computing device, then the information may be retrieved from a remote server.

At 716, a determination as to whether to continue tracking eye information is received. According to various embodiments, eye information may continue to be tracked as long as designated criteria are met. For example, eye information may continue to be tracked while a content guide is displayed on the display screen. As another example, eye information may be tracked for a designated period of time. As yet another example, eye information may be tracked or until a designated event occurs, such as the user making a selection of content.

In particular embodiments, some operations shown in FIG. 7 may be performed by a device other than the computing device on which the user interface is displayed. For example, in some cases devices may have limited computing power. In such instances the computing devices may perform minimal processing or analysis of the eye-tracking information identified by the sensor. Instead, the eye-tracking information may be transmitted to a server for analysis. In this case, operation 712 may involve transmitting eye-tracking information to a remote server for analysis and receiving an indication of an action to perform from the remote server.

FIG. 8 shows a method 800 for selecting an action to perform in a user interface, performed in accordance with various embodiments. According to various embodiments, the method 800 may be used at a computing device configured to process eye-tracking and other user preference information, to estimate user preferences, and to select content for presentation to the user. The method 800 may be used in conjunction with other methods, such as the user interface eye-tracking navigation method discussed with reference to FIG. 8.

At 802, a request to determine an action for a user interface is received. According to various embodiments, the request may be received from a computer program configured to provide a user interface for navigation by a user. The user interface may be provided in the form of a program guide or in another format. For example, the request may be received as part of operation 712 discussed with respect to FIG. 7.

At 804, eye-tracking information for a user is identified. According to various embodiments, the eye-tracking information may be similar to that described with respect to operations 706-710 shown in FIG. 7. The eye-tracking information may include data identifying, for example, a set of content items or screen portions viewed by the user as well as the actions or states of the user's eye or eyes before, during, and after viewing the areas. As discussed herein, other user preference information such as content ratings or selections may also be identified for analysis.

At 806, a content item or screen portion viewed by the user is selected for analysis. According to various embodiments, content items or screen portions may be selected in various ways. For example, content items or screen portions may be selected based on designated criteria, such as the length of time or frequency with which the content was viewed by the user. As another example, content items or screen portions may be selected based on a designated ordering, such as sequential ordering.

At 808, a gaze context is determined. According to various embodiments, a context for the user's gaze may represent an activity or action being performed when the gaze is detected. For example, if the user is searching for a particular piece of content, then observing that the user is quickly jumping from content item to content item may simply indicate that the user has not found the specific item the user is searching for rather than a lack of interest in all of those items. As another example, if the user seems to be browsing for any content of interest, then the user's attention or lack thereof with respect to a particular piece of content may be treated as evidence of preferences or intent to perform or not to perform an action. In particular embodiments, the context may be determined based on a state of the user interface. For example, the user interface may be presented in a search mode or a navigation mode when the user's gaze is detected. Alternately, or additionally, the context may be determined based on observed information such as the user's eye movements and actions.

At 810, gaze duration is determined. According to various embodiments, the length of time that a user's gaze is directed at a particular piece of content may provide evidence of the user's preferences or choices. For example, a relatively longer gaze duration may indicate interest in the content, while a relatively shorter gaze duration may indicate a lack of interest in the content. As another example, a relatively longer gaze duration may indicate a request to perform an action corresponding to the area of the display screen gazed at. In contrast, a relatively shorter gaze duration may indicate an effort by the user to determine the function of a particular user interface component, such as a button displayed on the display screen.

At 812, gaze frequency is determined. According to various embodiments, the frequency with which a user gazes at a particular piece of content or screen portion may indicate a preference. For example, if the user gazes at a particular piece of content once and then does not view it again, the user may be estimated not to prefer the content. Similarly, if the user gazes only once at a portion of the screen corresponding to a user interface action, then the action may not be performed. As another example, if the user frequently gazes at a particular piece of content, then the user may be estimated to be interested in the content. Similarly, if the user frequently gazes at a portion of the screen corresponding to a user interface action, then the action may be performed.

At 814, eye movement information is determined. As discussed herein, the eye movement information may include velocity, direction, and/or acceleration information. If a user quickly looks toward a particular piece of content or screen portion, then the user may be estimated to prefer the piece of content or to be interested in performing the action corresponding to the screen portion. Similarly, if a user quickly looks away from a particular piece of content or screen portion, then the user may be estimated to not prefer the piece of content or to not be interested in performing the action corresponding to the screen portion.

At 816, a user-interface action to perform is identified. As discussed herein, for example with respect to operations 806-814, various criteria may be used to estimate the user's preferred course of action. According to various embodiments, other eye-tracking related criteria as well as other criteria not related to eye-tracking information may be used instead of, or in addition to, the eye-tracking related criteria discussed herein. Other criteria that may be used may include, but are not limited to, user-provided user input, content ratings, content selections by the user, or demographic or biographic information.

According to various embodiments, the estimate of the user's preferred action. Then, subsequent eye-tracking information or other data may be used to update the. In this way, information about the user's preferred course of action in response to particular patterns of eye movement may be iteratively updated to allow the estimated action to more closely approach the user's actual preferred action.

At 818, a determination may be made as to whether to continue to monitor eye-tracking information. According to various embodiments, eye-tracking information may continue to be identified and analyzed until an action is performed, until the user interface is no longer displayed, until a request to cease monitoring is received, or until some other criteria are met.

According to various embodiments, personalized content may be selected based on the estimate of user preferences. For example, if a user is estimated to prefer a particular piece of content or type of content, then related content may be presented to the user. As another example, if a user is estimated to not prefer a particular piece of type of content, then some content may not be presented to the user. According to various embodiments, personalized content may be presented in a portion of the screen designated as including personalized content. Alternately, personalized content may not be designated as being personalized content.

According to various embodiments, various techniques may be used to select an action to perform based on eye-tracking or other information. For example, estimation techniques may be compared with explicit user input, preferences, selections, or ratings provided by the user. Then, the data may be compared to improve the estimates based on eye-tracking information alone. In this way, a particular pattern of eye behavior may be found to correspond to user preferences or actions in a particular way. Thus, the types of estimates described herein are provided only as examples. For example, in some cases, different users may have different correspondences between eye movements and preferred actions, and the selection process for actions may take these personalized differences into account.

FIG. 9 shows an example of a method 900 for providing a personalized user interface such as content guide for presentation at a client machine. According to various embodiments, the method 900 may be performed at a server in communication with a client machine. For instance, the method 900 may be performed at the server 102 shown in FIG. 1.

According to various embodiments, the method 900 may be used to receive and process information related to actions to be performed in a user interface. Eye-tracking information received from the computing device may be analyzed and/or combined with other information to select an action to be performed. In particular embodiments, the user may select content for playback, control the playback of content, navigate a user interface, or otherwise perform user interface actions at least in part via eye movements. The navigation may be performed with eye movements alone or may be performed via eye movements coupled with traditional user input such as touch screen or button press input.

According to various embodiments, the method 900 may also be used to estimate preferences associated with content displayed in a user interface. The preferences may be explicitly identified, such as information related to content selections and content ratings identified by a user. The preferences may also be implicitly identified, such as information related to eye tracking of an individual in proximity to a client device. Based on this user preference information, personalized content may be identified for selection or presentation at the client device.

At 902, a user at the client machine is identified. According to various embodiments, the user may be identified via various techniques. For example, the user may be logged in to a user account associated with content acquisition or management, such as a Netflix account, a content provider account, a cable television account, or an account associated with a content selection interface provided by a mobile device application developer such as MobiTV. As another example, the user may provide identification information upon request to facilitate improved preference identification.

According to various embodiments, the user may be identified via biometric identification. For instance, the optical sensor used to track the user's eye information may also be used to capture visual identification information that may be used to identify the user. In particular embodiments, biometric identification may be used to separately identify different users who share digital accounts, such as different people who share a television within a home.

At 904, a user interface such as a content guide is transmitted to the client machine. According to various embodiments, the content guide may include any content capable of being presented at the client machine or a related device. The content may include advertising, content freely available to the user such as broadcast television, content available to the user under a paid subscription such as cable television, or content available for purchase by the user such as video programs downloadable via the iTunes service.

According to various embodiments, the content guide may be personalized based on user information. For instance, the user may have previously selected various reality television shows for viewing and/or provided rating information indicating a preference for such shows. In this case, the user may be provided with a content guide that emphasizes reality television programming. This information may be collected based on the current viewing session or may be determined based on past viewing sessions for which user preference information was previously stored.

At 906, eye tracking information is received from the client machine. The eye tracking information may include any information related to the location or duration of a user's eye gaze or eye movement. According to various embodiments, the specific eye tracking information captured may depend on the capabilities of the client device. For instance, some client devices may include more sophisticated optical sensors than other client devices.

According to various embodiments, the information transmitted from the client device to the server may include raw eye tracking data received at the client machine. Alternately, or additionally, the raw eye tracking data may be processed at the client machine to identify information such as particular content items that were focused on by the user. In particular embodiments, whether the eye tracking information is processed at the client device and/or at the server may depend on the capabilities of the client device. For relatively simple client devices with limited processing capabilities, such as some mobile devices the information may be sent to the server for processing. For sophisticated client devices with relatively powerful processing capabilities, such as many laptops and desktop computers, some or all of the data analysis may be performed at the client device.

At 908, the eye tracking information is stored on a storage device. For instance, the eye tracking information may be stored in the user information storage module 106 discussed with respect to FIG. 1.

In some embodiments, the eye tracking information may be stored as raw data. For instance, the gaze direction, gaze dwell, eye movement velocity, eye movement acceleration, facial expressions, head location, head orientation, or blink frequency information may be stored.

In some embodiments, the eye tracking information may be stored as processed or analyzed data. For example, an indication that the user gazed at a particular content item for an identified period of time may be stored. As another example, a preference for a particular piece or type of content determined based on eye tracking information may be stored. As another example, a request for an action to be performed based on eye tracking information may be stored.

At 910, an action to perform based on the eye tracking information is identified. According to various embodiments, the action to perform may be the navigation to a different, previously undisplayed portion of the digital program guide. For example, in a grid view, the user may gaze at the bottom or top of the screen when the digital program guide is displayed to navigate to the next or previous page in the digital program guide. As another example, the user may gaze at the left or right of a grid view guide to display content available in earlier or later time periods. As yet another example, the user may gaze at a particular content item or content category in a mosaic programming guide to view more content of that time.

According to various embodiments, the action to perform may be the transmission of an updated, personalized content guide. The updated content guide may include personalized content identified based on the eye tracking information. For example, if the user is frequently observed focusing on content related to sports games that include particular teams, then the user may be presented with a customized content channel that includes the user's preferred teams.

According to various embodiments, the action to perform may be moving within the user interface to change the content displayed in the user interface, the perspective with which the content is viewed, or the level of detail at which the content is displayed. For example, the action may be zooming in or out to display a different level of detail within the user interface. As another example, the action may be scrolling the user interface to display a different region or set of content items. As yet another example, the action may be panning a viewpoint from which the user interface is viewed to display a different area of the user interface when the user interface contains more information than is displayed on the screen at one time.

According to various embodiments, the action to perform may be confirming a previously-selected action within the interface. For instance, the user may gaze at the edge of the screen for a designated period of time to pan to the next page. However, when such a gaze is detected, the user may be presented with an opportunity to confirm the selected action. For example, an arrow pointing to the next page may appear, and the user may be required to gaze at the arrow for a designated period of time, such as one second, to complete the requested navigation action of panning to the next page. As another example, the user may need to blink a designated number of times in succession (e.g., two or three blinks) while gazing at the edge of the screen in order to complete the requested navigation action of panning to the next page. As yet another example, the user may gaze at a navigation button displayed on the display screen to select an action and may nod his or her head to confirm the selected action.

As discussed herein, various criteria may be used to estimate the user's preference. In particular embodiments, the estimate of user preference may be influenced by pupillary dilation of the user's eye or eyes. For example, a relatively dilated pupil may indicate interest in the content item viewed, while a relatively contracted pupil may indicate a lack of interest in the content item. According to various embodiments, other eye-tracking related criteria as well as other criteria not related to eye-tracking information may be used instead of, or in addition to, the eye-tracking related criteria discussed herein. Other criteria that may be used may include, but are not limited to, user-provided content

According to various embodiments, the action to perform may be the selection of content for presentation from a digital program guide. The selected content may include personalized content or may be other content included for selection in the content guide. The mechanism for selecting the content may differ depending on the particular client device being used to display the content. For example, the user may gaze at a content item for a designated period of time. As another example, the user may press a touch screen, use a remote control, or click on an area of the screen with a mouse to select a content item.

At 912, the updated user interface is transmitted to the client machine for presentation. According to various embodiments, the updated user interface may be transmitted from various sources. For example, an updated content guide may be transmitted from the content guide generation module 110 via the network interface 108.

As another example, selected content is transmitted to the client machine for presentation. In particular embodiments, selected content may be streamed over a network to the client device. Alternately, selected content may be downloaded and then presented for playback at the client device. According to still other techniques, the content may already be located locally at the client device, such as stored on a digital video recorder (DVR) device, and an indication to play the selected content may be transmitted to the client device.

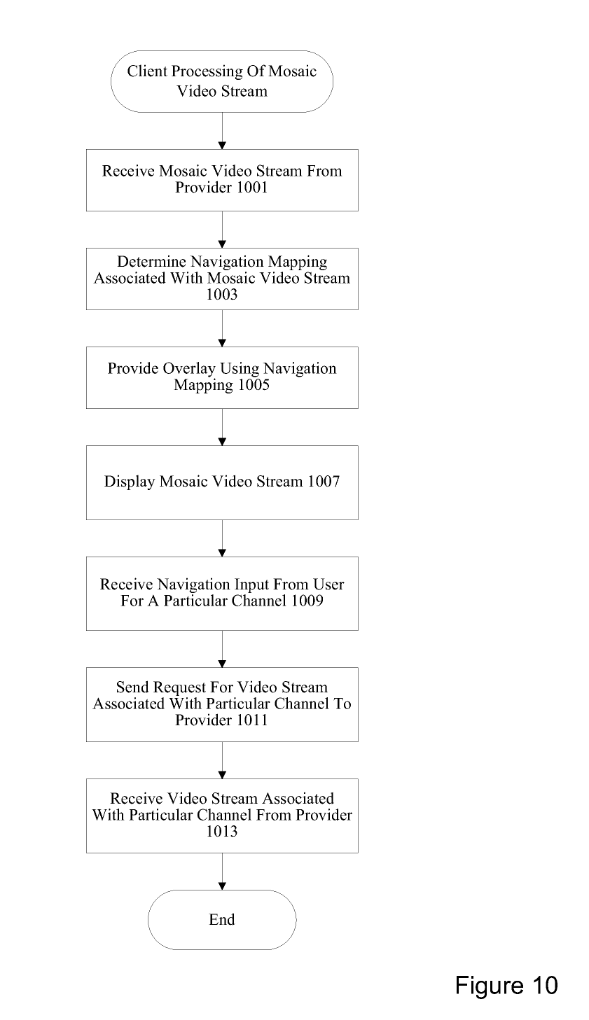

FIG. 10 is a flow process diagram showing one example of a technique for client processing of a mosaic video stream. At 1001, a mosaic video stream is received from a provider. According to particular embodiments, a service provider or content provider transmits numerous channels with mosaic video streams. In particular examples, a mosaic video stream showing multiple channels is provided on a single channel. Some mosaic video stream channels may show streams for a particular category of content. A user can elect to receive a particular mosaic video stream. At 1003, a client device determines navigation mapping information associated with a mosaic video stream. In particular examples, the navigation mapping is a list of channels and corresponding coordinates. In other examples, the navigation mapping is a template with particular associated video clips. The navigation mapping may be transmitted with a mosaic video stream or may be provided separately. At 1005, a device provides an overlay using the navigation mapping information. At 1007, a mosaic video stream 1007 is displayed with the overlay. The overlay allows a user the ability to select channels without the mosaic video stream having to be interactive. Receiving a mosaic video stream from a provider also frees a device from having to aggregate or render multiple video streams from separate channels.

At 1009, a device receives navigation input from a user for a particular channel. The navigation input may be a selection using the overlay of a particular position corresponding to a particular channel. Alternatively, navigation input may be text or numeric entries identifying a particular channel in the mosaic video stream. At 1011, the overlay allows a device to send a request for a selected video stream to a provider. At 1013, a selected video stream associated with a particular channel is received from a provider.

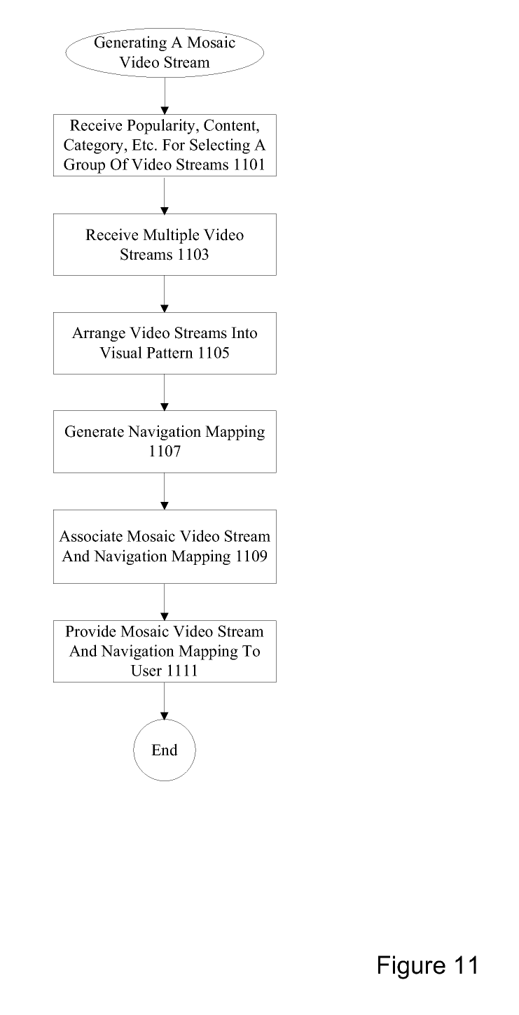

FIG. 11 illustrates one particular example of server processing for generating a mosaic video stream. At 1101, a server receives popularity, content, category information etc for selecting a group of video streams for inclusion in mosaic video stream. At 1103, the server receives multiple video streams. At 1105, the video streams are arranged into a visual pattern. At 1107, navigation mapping information is generated. At 1109, a mosaic video stream is associated with the navigation mapping. At 1111, the mosaic video stream and navigation mapping is provided to a user.

While the invention has been particularly shown and described with reference to specific embodiments thereof, it will be understood by those skilled in the art that changes in the form and details of the disclosed embodiments may be made without departing from the spirit or scope of the invention. It is therefore intended that the invention be interpreted to include all variations and equivalents that fall within the true spirit and scope of the present invention.

Because such information and program instructions may be employed to implement the systems/methods described herein, the present invention relates to tangible, machine readable media that include program instructions, state information, etc. for performing various operations described herein. Examples of machine-readable media include hard disks, floppy disks, magnetic tape, optical media such as CD-ROM disks and DVDs: magneto-optical media such as optical disks, and hardware devices that are specially configured to store and perform program instructions, such as read-only memory devices (ROM) and programmable read-only memory devices (PROMs). Examples of program instructions include both machine code, such as produced by a compiler, and files containing higher level code that may be executed by the computer using an interpreter.

Although many of the components and processes are described above in the singular for convenience, it will be appreciated by one of skill in the art that multiple components and repeated processes can also be used to practice the techniques of the present invention.

In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

What is claimed is:

1. A method comprising:
presenting a user interface on a display screen at a computing device, the user interface providing a plurality of actions to perform based on user input information for presenting the user interface being received from a remote server;
receiving eye tracking information via an optical sensor at the computing device, the eye tracking information describing a state of one or both eyes of an individual located proximate to the computing device;
transmitting at least a portion of the eye tracking information to the remote server; and
selecting one of the plurality of actions for performance based on the received eye tracking information.

2. The method recited in claim 1, wherein the user interface comprises an electronic program guide including a first plurality of content items for selection.

3. The method recited in claim 2, wherein the action to perform comprises a selection for presentation of one of the first plurality of content items.

4. The method recited in claim 2, wherein the action to perform comprises updating the user interface to include a second plurality of content items for selection, the second plurality of content items being different than the first plurality of content items.

5. The method recited in claim 1, wherein the selected action is selected from a group consisting of: panning within the user interface, zooming within the user interface, scrolling within the user interface, and confirming a previously selected action within the user interface.

6. The method recited in claim 1, wherein the eye tracking information identifies a direction in which the eyes are focused and a time duration during which the eyes are focused in the identified direction.

7. The method recited in claim 1, the method further comprising:
transmitting at least a portion of the eye tracking information to a server; and
receiving an updated user interface from the server.

8. The method recited in claim 1, wherein the eye tracking information comprises movement information, the eye movement information identifying a direction, a velocity, or an acceleration of eye movement.

9. A method comprising:
transmitting, from a server, a user interface for presentation on a display screen at a client machine, the user interface providing a plurality of actions to perform based on user input;
receiving, from the client machine, eye tracking information via an optical sensor at the client machine, the eye tracking information describing a state of one or both eyes of an individual located proximate to the client machine;
selecting one of the plurality of actions for performance based on the received eye tracking information; and
transmitting, from the server, an instruction for performing the selected action at the client machine.

10. The method recited in claim 9, wherein the user interface comprises an electronic program guide including a first plurality of content items for selection.

11. The method recited in claim 10, wherein the action to perform comprises a selection for presentation of one of the first plurality of content items.

12. The method recited in claim 10, wherein the action to perform comprises updating the user interface to include a second plurality of content items for selection, the second plurality of content items being different than the first plurality of content items.

13. The method recited in claim 9, wherein the selected action is selected from a group consisting of: panning within the user interface, zooming within the user interface, scrolling within the user interface, and confirming a previously selected action within the user interface.

14. The method recited in claim 9, wherein the eye tracking information identifies a direction in which the eyes are focused and a time duration during which the eyes are focused in the identified direction.

15. The method recited in claim 9, wherein the eye tracking information comprises movement information, the eye movement information identifying a direction, a velocity, or an acceleration of eye movement.

16. A computing device comprising:
memory;
a display screen operable to present a user interface, the user interface providing a plurality of actions to perform based on user input;
an optical sensor operable to receive eye tracking information, the eye tracking information describing a state of one or both eyes of an individual located proximate to the computing device;
a communications interface operable to transmit at least a portion of the eye tracking information to a remote server; and
a processor operable to select one of the plurality of actions for performance based on the received eye tracking information.

17. The computing device recited in claim 16, wherein the user interface comprises an electronic program guide including a first plurality of content items for selection.

18. The computing device recited in claim 17, wherein the action to perform comprises a selection for presentation of one of the first plurality of content items.

19. The computing device recited in claim 17, wherein the action to perform comprises updating the user interface to include a second plurality of content items for selection, the second plurality of content items being different than the first plurality of content items.

20. The computing device recited in claim 16, wherein the selected action is selected from a group consisting of: panning within the user interface, zooming within the user interface, scrolling within the user interface, and confirming a previously selected action within the user interface.
